(19) United States
(12) Patent Application Publication
(10) Pub. No.: US 2011/0035203 A1
(43) Pub. Date: Feb. 10, 2011

(54) SYSTEM LEVEL POWER EVALUATION METHOD

(76) Inventors: Damian Jude Dalton, Blackrock (IE); Andrew John McCarthy, Dun Brinn Athy (IE); Robert Neilson Quigley, Blackrock (IE); Hugo Michael Leeney, Dundrum (IE)

Correspondence Address: HOLLAND & KNIGHT LLP, 10 ST. JAMES AVENUE, BOSTON, MA, 02116-3889, US

(21) Appl. No.: 12/681,547

(22) PCT Filed: Oct. 2, 2008
(86) PCT No.: PCT/EP2008/063261

§ 371 Date: Oct. 18, 2010

(30) Foreign Application Priority Data
Oct. 3, 2007 (IE) S2007/0707

(51) Int. Cl. G06F 17/50

(52) U.S. Cl. 703/14

(57) ABSTRACT

This invention relates to a system level power evaluation method in which detailed power macro-models (PMM) are created for operations of modules. These PMMs are stored in memory. A system level circuit description (SLCD) is evaluated using the PMMs stored in memory that are relevant to that SLCD and using other PMMs that are generated for operations of modules that do not have PMMs stored in memory. In this way, a highly accurate and computationally efficient power evaluation of the SLCD is possible. Furthermore, the user implementing the method may define a case, which relates to an operation of a module and has a PMM associated therewith, in a highly flexible manner that allows for more abstract analysis of the SLCD to be carried out. A case may relate to a single operation of a module, a plurality of operations of a module or operation(s) of a plurality of modules.

### INTRODUCTION

This invention relates to a method of evaluating the power characteristics of a system level circuit description.

One of the most important considerations when designing digital circuits and System on Chip (SoC) designs in particular is the power consumption of the design. It is highly desirable to minimise the power consumption of these designs. Heretofore, numerous power evaluation tools and methods have been proposed to accurately estimate the power consumption of digital circuit designs prior to the physical realisation of those designs. The vast majority of these power evaluation tools operate on a gate level design of the digital circuit.

One such known method and tool is that described in PCT Publication No. WO2006/038207 (University College Dublin) entitled “A method and processor for power analysis in digital circuits”. This document describes a modified processor, otherwise referred to as the Energy Investigation for Gate and Module Analysis (ENiGMA) tool to calculate the power consumption of gate level digital circuits in a relatively fast and efficient manner, particularly when compared with other gate level power evaluation tools and methods. The ENiGMA tool has at its core a parallel processor for logic event simulation, otherwise referred to as an APPLES processor. A more thorough description of the APPLES processor's structure and operation may be found in PCT Publication No. WO01/01298 (University College Dublin). Further modifications to the APPLES processor's structure and operation are described in WO03/079237 (Neosera Systems Limited). The APPLES processor is used to simulate the gate level circuit and monitor transitions of the gates in the digital circuit and the ENiGMA tool thereafter uses the results of the simulation to determine the power consumption based on the states and transitions of the gates in the digital circuit.

Although gate level evaluation of digital circuits is seen as a highly accurate way of determining the power characteristics of a digital circuit, there are numerous problems with this approach. First of all, power estimation at gate level is computationally expensive and therefore can take a significant amount of time to perform. This is often a bar to using such techniques. For example, in order to obtain a comprehensive understanding of the power characteristics of a new design in mobile or ubiquitous computing applications, it is necessary to simulate the design, often by executing the embedded software that will form part of the realised design, over a large number of cycles, typically of the order of 10⁵ or 10⁶ cycles. This simulation can take a number of days to perform and accordingly is impractical in most circumstances.

A second problem with gate level simulation is that the simulation is carried out at a relatively late stage of the design process, after the initial transactional, behavioural and register transfer level (RTL) stages of the design cycle. Therefore, significant investment must already have been made in the design prior to the power evaluation and in the worst case scenario the design will have to be abandoned after significant resources have been invested. Thirdly, amendments to the design at the gate level stage have a relatively limited impact on power consumption reduction.

It is preferable therefore to provide a power evaluation method and tool that operates at a higher level of abstraction as evaluation at an earlier stage of development is less computationally expensive, may be done at a stage where less investment into the design has been made and finally will have a greater impact and maximise power reduction in the design. Various system level power evaluation methodologies and tools for performing power analysis on digital circuits have been proposed.

One such methodology is that described in the paper by Bona, Zaccaria and Zafalon entitled “System Level Power Modelling and Simulation of High-End Industrial Network-on-Chip” IEEE Proc of Design, Automation and Test in Europe Conference (DATE '04), Paris, France, March 2004, hereinafter referred to as Bona. Bona describes a methodology for automatically generating energy representations of a versatile and parametric on-chip communication block (STBus). It attempts to allow power profiling of an entire platform from the very early stages of the system design when only a software model of the design exists. Bona is also concerned with addressing the issues of slow simulation at gate and device level. Bona has developed a system simulation in SystemC that relies on high level profiling statistics to determine the energy cost using a library of energy views and a dedicated application programming interface (API). The STBus energy representations are based on a set of parametric analytic equations that are individually accessed by the simulator to compute the eventual energy figures. An extensive set of gate level power simulations are launched within a testbench generation suite and representations are stored into a centralised power representation database. Only one representation is stored for each component and target technology.

Another methodology is that described in the paper by Dhanwada, Lin and Narayanan entitled “A Power Estimation Methodology for SystemC Transaction Level Models” IEEE/ACM/IFIP International Conference on Hardware/Software Codesign and System Synthesis, New York, September 2005, hereinafter referred to as Dhanwada. Dhanwada describes a methodology for performing system level power estimation for different scenarios executed on transaction level models. There is described an approach to augment SystemC transaction level models to perform transaction level power estimation. Dhanwada incorporates power estimation techniques into a SystemC functional model designed to run embedded software. This paper is partially concerned with setting up a characterisation methodology that combines all aspects of a detailed model in the process of generating an abstract transaction level power model.

Dhanwada describes an example in which there are existing legacy performance or architecture analysis representations and proposes an approach for power characterisation and augmenting the representations to permit system level power estimation. Dhanwada generates a hierarchical transaction level power (HTLP) tree structure which captures transaction level power information for a particular core. The information is used to augment the SystemC simulation platform with power information. The tree appears to be determined based on instructions and power consumption is characterised according to a task or instruction and they use power simulation tools with the parasitics to generate power characterisation information. The gate level netlist of the core is used to obtain parasitic data. The HTLP tree structure is populated with power data derived from a gate level power simulation.

U.S. Pat. No. 6,865,526, in the name of Henkel et al entitled “Method for Core-based System-Level Power Modelling using Object-Oriented Techniques” and hereinafter referred to as Henkel, discloses a method for reducing power consumption by using power estimation data obtained from the gate-level of a core's representative input stimuli data and propagating power the estimation data to a higher system level model. Henkel discloses a method for determining a fast and accurate estimation of the power requirement of a VLSI circuit. Core models of circuit elements incorporating instruction level simulation coupled with gate level energy analysis are used in these estimations. This patent describes a method for energy and power estimation of a core-model based embedded system by capturing gate level energy simulation data, deploying the gate level simulation data in an algorithmic level executable specification, wherein the captured gate level data simulation data correlates to a plurality of instructions, and executing the algorithmic-level executable specification to obtain energy estimations for each instruction. Henkel describes how power data from gate level simulations is used to estimate the power and performance of a core using object oriented models. Henkel however would appear to focus on an instruction based approach.

It is an object therefore of the present invention to provide a system level power estimation method and tool that overcomes at least some of the disadvantages with the known methods and tools.

### STATEMENTS OF INVENTION

According to the invention there is provided a system level power evaluation method comprising the steps of:
providing a system level circuit description (SLCD) containing a plurality of operations of modules for analysis;
reviewing the SLCD and identifying those operations of modules of the SLCD that are equivalent to a previously analysed case, a case comprising an operation of a module, and those operations of modules of the SLCD that have no equivalent previously analysed case;
for each operation of module of the SLCD that is equivalent to a previously analysed case, retrieving a power macro-model of the previously analysed case from memory and assigning that power macro-model to that operation of module in the SLCD;
for each operation of module of the SLCD that has no equivalent previously analysed case, generating a power macro-model for each operation of module and assigning that generated power macro-model to that operation of module in the SLCD; and
using the plurality of power macro-models, sample input vectors and sample output vectors, evaluating the power consumption of each of the operation of modules in the SLCD and summing the power consumption of each of the operation of modules to provide a system level power estimate.

By having such a method, it is possible to carry out rapid evaluation of a number of prototypes at a system level. This was not heretofore possible. It is possible to evaluate power consumption of a circuit relative to the embedded system level code. This is highly advantageous and was not heretofore possible. Furthermore, the method is such that it will be able to be performed regardless of the system circuit level description to be analysed and is not dependent on a state based description of the system.

In one embodiment of the invention the method comprises the initial step of the user defining a case, the case comprising an operation of a module. In one embodiment of the invention the method comprises the initial step of the user defining the case, the case comprising a plurality of operations of a module. In one embodiment of the invention, the method comprises the initial step of the user defining the case, the case comprising a plurality of modules.

In one embodiment of the invention there is provided a method in which the step of generating a power macro-model further comprises the steps of:
obtaining a gate level description of the circuitry required for the transaction;
simulating the gate level description of the circuitry required for the transaction using the plurality of sample input vectors and sample output vectors;
calculating the gate level power consumption for the sample vectors used in the simulation; and
constructing a power macro model using a plurality of sample input vectors, sample output vectors and calculated power consumption values for the sample vectors.

It will be understood that each case may comprise one or more physical modules operable in response to a transaction. By physical module, what is meant is a component that is represented in the programming code such as the VHDL or Verilog code. It is also possible to generate one comprehensive power macro-model that consists of all the constituent physical modules integrated into one module in the case. Additionally or alternatively it is possible to generate power macro-models of the individual physical modules of the case.

In one embodiment of the invention there is provided a method in which in calculating the gate level power consumption, the method incorporates appropriate static and dynamic power models, interconnect information, input and stimuli activity and internal switching activity.

In one embodiment of the invention there is provided a method in which the generated power macro-models are stored in memory for subsequent use in the power evaluation of other SLCDs.

In one embodiment of the invention there is provided a method in which the step of generating a power macro-model comprises generating a four dimensional table indexed by statistical energy macro model parameters. Alternatively, a five or more dimensional table could be generated to form the power macro-model.

In one embodiment of the invention there is provided a method in which the statistical energy macro model parameters used to index the four dimensional table comprise: (a) Input probability, (b) Average input transition density, (c) Average input spatial correlation co-efficient and (d) Average output zero delay transition density.

In one embodiment of the invention there is provided a method in which the statistical energy macro model parameters are calculated for each input vector set together with the energy value. In one embodiment of the invention there is provided a method in which the sample input vectors are used to index a value of power consumption in the power macro model.

In one embodiment of the invention there is provided a method in which the power macro-models of cases are stored in a central database. In one embodiment of the invention there is provided a method in which the cases are defined by: (a) a circuit description; and (b) a context of the input stimuli under which the circuit is exercised.

In one embodiment of the invention there is provided a method in which the circuit description further comprises a gate level netlist of the case.

In one embodiment of the invention there is provided a method in which the gate level netlist comprises one of a Verilog and a VHDL (Very High Speed Integrated Circuit Hardware Description Language) netlist definition of a circuit generated by the synthesis of a Register Transfer Level (RTL) description of the circuit. Although VHDL and Verilog are seen as particularly suitable, it is envisaged that other net list description languages could be used instead.

In one embodiment of the invention there is provided a method in which the context of the input stimuli under which the circuit is exercised further comprises a testbench description. Preferably, the testbench description is written in one of Verilog and VHDL. Preferably, the testbench description is written at one of the RTL and the gate level.

In one embodiment of the invention there is provided a method in which the testbench description is partitioned into segments. In one embodiment of the invention there is provided a method in which the segments of the testbench description are annotated.

In one embodiment of the invention there is provided a method in which the testbench segments are identified by segment identifiers including headers and terminator text embedded in the testbench description.

In one embodiment of the invention there is provided a method in which the testbench segments are defined by segment descriptors including at least one of keywords and a description embedded in the testbench description. In one embodiment of the invention there is provided a method in which the segment identifiers and segment descriptors are entered in the testbench description in comment format.

In one embodiment of the invention there is provided a method in which the method further comprises the step of entering a segment identifier or descriptor into the testbench description, and in which during the step of entering one of the segment identifier and descriptor, a pair of windows are presented to the user, a first window with the testbench description and a second window with the annotated testbench description with segment identifiers and descriptors inserted therein.

In one embodiment of the invention the method further comprises the step of a database controller tree parser parsing the annotated testbench description and producing segment trees in the tree database.

In one embodiment of the invention there is provided a method in which the segment tree comprises a plurality of leaves, each leaf in the segment tree corresponding to a case and in which the segment identifiers correspond to a path in the tree, and the database controller's tree parser produces a unique identity number for each leaf in the tree.

In one embodiment of the invention, there is provided a method in which a file management system such as a version controlled filing structure is used instead or together with a database for storing segment trees.

In one embodiment of the invention there is provided a method in which a monitor file is produced, the monitor file comprising the original testbench description and a pair of print statements associated with each segment in the testbench description, one at the beginning of the segment and the other at the end of a segment and in which the print statements cause the time of execution of the print statement to be printed to a designated file along with an identifier of the segment.

In one embodiment of the invention the method further comprises the step of inserting commands in the overlay/monitor file to indicate which of the modules will have a power macro model generated from their simulated activity.

In one embodiment of the invention there is provided a method in which those modules identified as requiring power macro models are simulated and have power macro models constructed from the simulation.

In one embodiment of the invention there is provided a method in which the annotated testbench description is parsed and thereafter compiled.

In one embodiment of the invention there is provided a method in which the step of parsing the annotated testbench description comprises replacing all overlays and commands with one of Verilog and VHDL, PLI (Programming Language Interface) and FLI (Foreign Language Interface) code structures and generating a monitor file.

In one embodiment of the invention there is provided a method in which the step of compiling the parsed annotated testbench description further comprises generating an executable file and thereafter simulating the executable file.

In one embodiment of the invention there is provided a method in which the input and output activity of each of the modules is monitored for each testbench segment during simulation.

In one embodiment of the invention there is provided a method in which the input and output activity are entered into a testbench module activity (TMA) file. The TMA therefore comprises the activity data of the segments/cases that were being analysed at that time.

In one embodiment of the invention there is provided a method in which the TMA file further contains:
(a) the Unique Identity Number (UIN) of each active segment;
(b) internal physical module activity of all testbench segments active in the simulation;
(c) identification of cases for which power macro-models are to be created;
(d) input/output parameter lists of power macro-models;
(e) the cell library into which the physical modules will be synthesised; and
(f) a unique file identifier of each synthesised physical module, a synthesised file ID (SFI).

In one embodiment of the invention there is provided a method in which the TMA file is transferred to a power macro-model generator.

In one embodiment of the invention there is provided a method in which the power macro-model generator acquires or produces the synthesised gate-level version in the designated cell library for every physical module in the TMA file.

In one embodiment of the invention there is provided a method in which for each segment, the power macro-model generator transfers the associated synthesised files to an ENiGMA system operating using an APPLES processor together with the appropriate time sequenced vector input list.

In one embodiment of the invention there is provided a method in which the ENiGMA system computes the total power consumption of each testbench segment.

In one embodiment of the invention there is provided a method in which the ENiGMA system computes the power consumption of each physical module in each testbench segment.

In one embodiment of the invention there is provided a method in which a gate level power analysis tool computes the total power of a testbench segment. It is envisaged that Prime Power® or Prime Time®, as sold by Synopsys® could be used instead of the ENiGMA tool.

In one embodiment of the invention there is provided a method in which the ENiGMA system calculates the power consumption on a cycle by cycle basis.

In one embodiment of the invention there is provided a method in which the power consumption data is stored for subsequent use by the power macro model generator.

In one embodiment of the invention there is provided a method in which the power macro-model generator, using the input and output vector activity data and the power consumption data, generates a four dimensional macro-model table for each monitored testbench segment that does not already have a macro-model associated therewith.

In one embodiment of the invention there is provided a method in which the four dimensional table has the following parameters:
(a) Input probability;
(b) Average input transition density;
(c) Average input spatial correlation co-efficient;
(d) Average output zero delay transition density;
along with a corresponding power value.

In one embodiment of the invention there is provided a method in which the components are augmented with the batch time which indicates which batch sample was used from an input vector stream in the generation of the four dimensional table entry.

In one embodiment of the invention there is provided a method in which the method comprises the step of generating a time based energy profile of the associated energy modules.

In one embodiment of the invention there is provided a method in which the method comprises the step of recording the frequency of operation during the simulation.

In one embodiment of the invention there is provided a method in which the method comprises the step of recording the operating voltage during the simulation.

In one embodiment of the invention there is provided a method in which the method further comprised the step of generating an aggregate power value for the entire testbench including total power consumed, consumption time, frequency of operation and operating voltage.

In one embodiment of the invention there is provided a method further comprising the step of the power macro-model generator transferring:
(a) the power macro models
(b) the UINs
(c) the SFIs
(d) the aggregate power values
(e) the frequency information
(f) the voltage information
   to a database controller and in which the database controller inserts the received information into the central database.

In one embodiment of the invention the method further comprises the step of the database controller updating links to any other power macro-model with the same SFI as the power macro models being inserted into the database.

In one embodiment of the invention the method comprises the step of generating a single larger power macro model from constituent tables distributed in the database.

In one embodiment of the invention the method comprises the step of using a case in the database as an overlay in a SLCD for system level power evaluation.

In one embodiment of the invention the method comprises the step of annotating the SLCD file with overlays.

In one embodiment of the invention the method comprises the step of parsing the annotated SLCD file and translating the parsed SLCD file into a monitor SLCD file containing trace commands.

In one embodiment of the invention there is provided a method in which the trace commands comprise a print command to print the segment UIN and the time of execution of the print command.

In one embodiment of the invention the method further comprises the step of compiling the monitor SLCD file.

In one embodiment of the invention the method further comprises the step of executing the compiled SLCD file.

In one embodiment of the invention there is provided a method in which the UIN and the trace commands are stored in a trace file.

In one embodiment of the invention there is provided a method in which the trace file is parsed and the time sequence of the UINs is determined.

In one embodiment of the invention there is provided a method in which the power consumption and duration of each UIN is extracted from the testbench segment database through the UIN index.

In one embodiment of the invention there is provided a method in which a time line of power consumption is generated.

In one embodiment of the invention there is provided a method in which overlays are combined into an operational group.

In one embodiment of the invention there is provided a method in which the operational groups are distinguished by voltage and operating frequency.

In one embodiment of the invention the method further comprises the step of simulating voltage islands at a system level. In one embodiment of the invention the method further comprises the step of simulating frequency scaling at a system level.

In one embodiment of the invention the method further comprises the step of determining optimal voltage and frequency operating conditions at a system level using operational groups. Operational groups are a collection of physical modules grouped together in a common physical block and operating under the same operating conditions as each other.

In one embodiment of the invention there is provided a method in which the method further comprises the step of determining optimal gated clocking operating conditions at a system level using the operational groups.

In one embodiment of the invention there is provided a method in which the method further comprises using combinatorial optimisation techniques to determine the optimal operating conditions.

In one embodiment of the invention there is provided a method in which the combinatorial optimisation technique used is a simulated annealing technique.

In one embodiment of the invention there is provided a method in which the power effect in the SLCD at a system level may be determined by providing average length and capacitance values of interconnect wires. Furthermore, it is possible to provide capacitance values of interconnect wires between gates in a module, between cases and between operational groups.

### DETAILED DESCRIPTION OF THE INVENTION

The invention will now be more clearly understood from the following description of some embodiments thereof, given by way of example only with reference to the accompanying drawings in which:

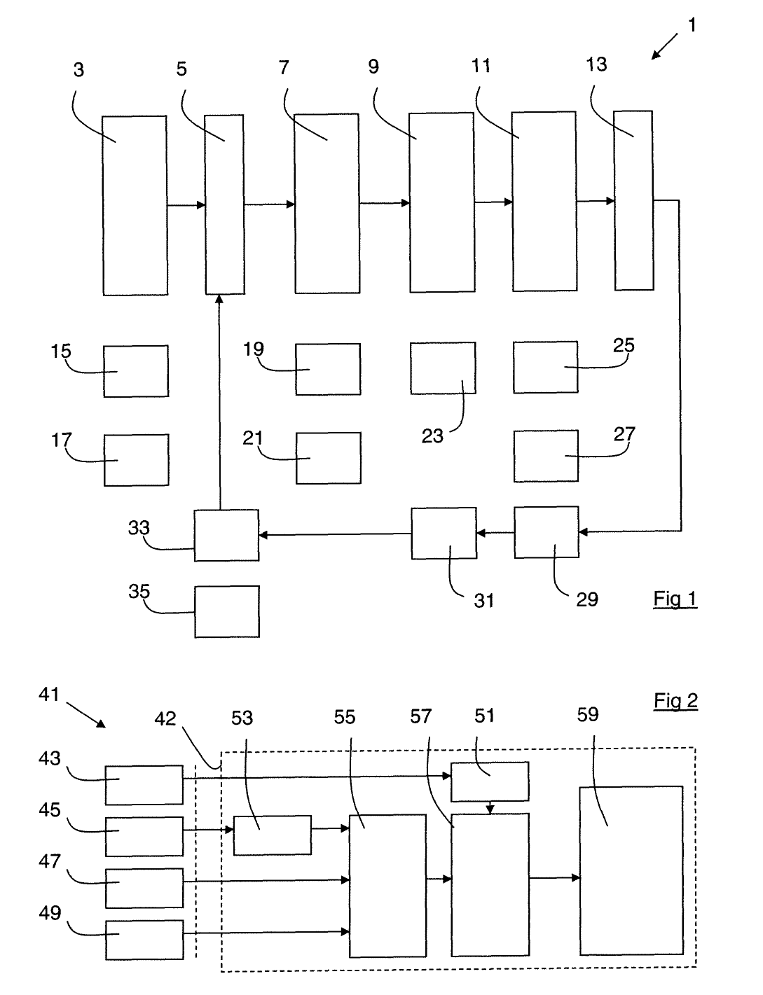

FIG. 1 is a diagrammatic representation of a parallel processor for logic event simulation (APPLES) according to the art;

FIG. 2 is a diagrammatic representation of a system incorporating an ENiGMA processor;

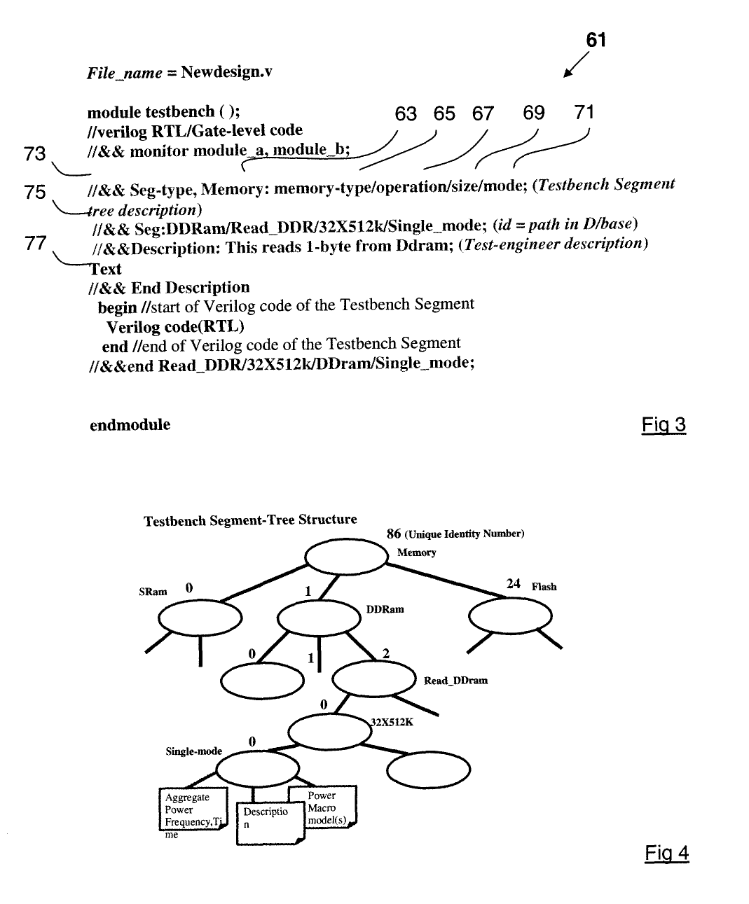

FIG. 3 is a diagrammatic representation of the definition and structure of a segment;

FIG. 4 is a diagrammatic representation of a Testbench Segment tree;

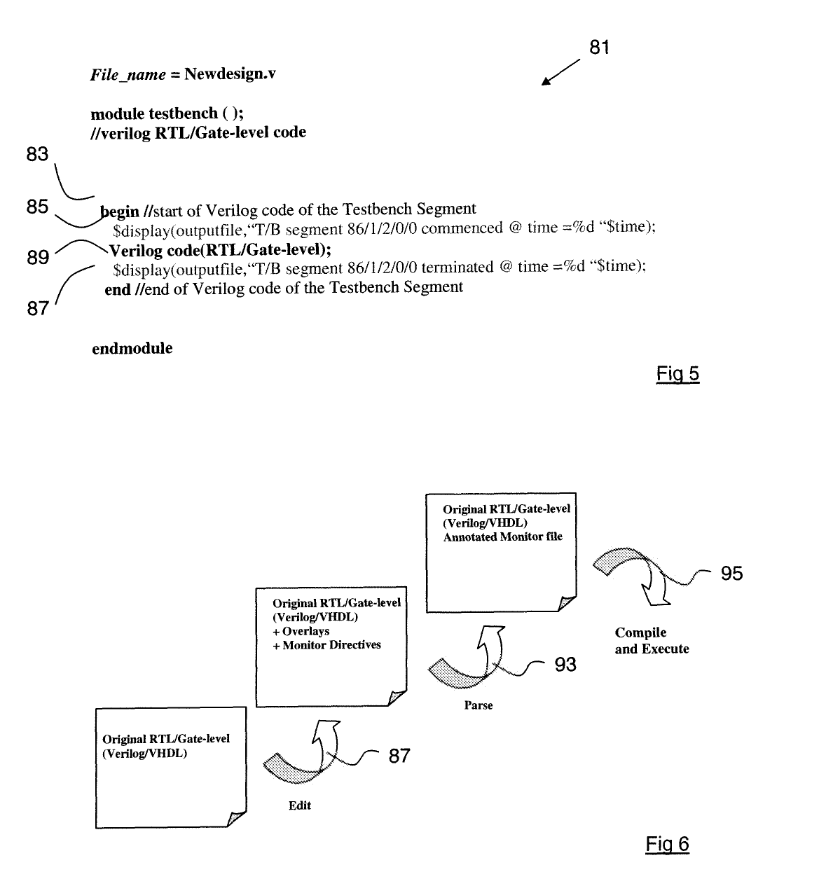

FIG. 5 is a diagrammatic representation of a monitor file;

FIG. 6 is a diagrammatic representation of the sequence in which the files are generated;

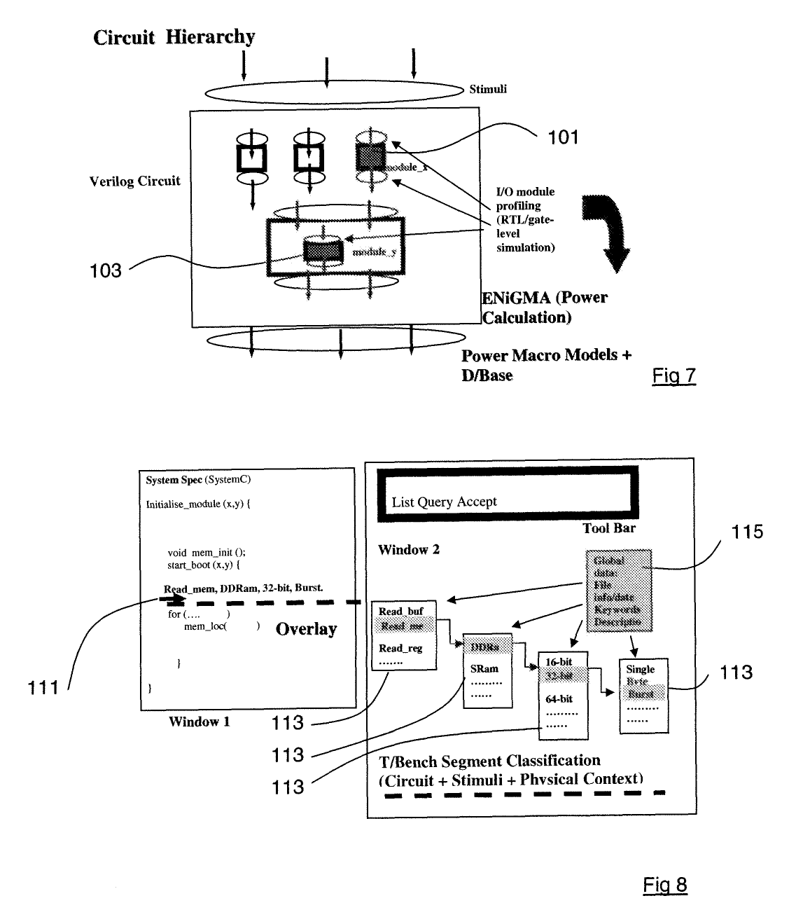

FIG. 7 shows active modules being monitored;

FIG. 8 shows a SystemC overlay insertion according to the present invention;

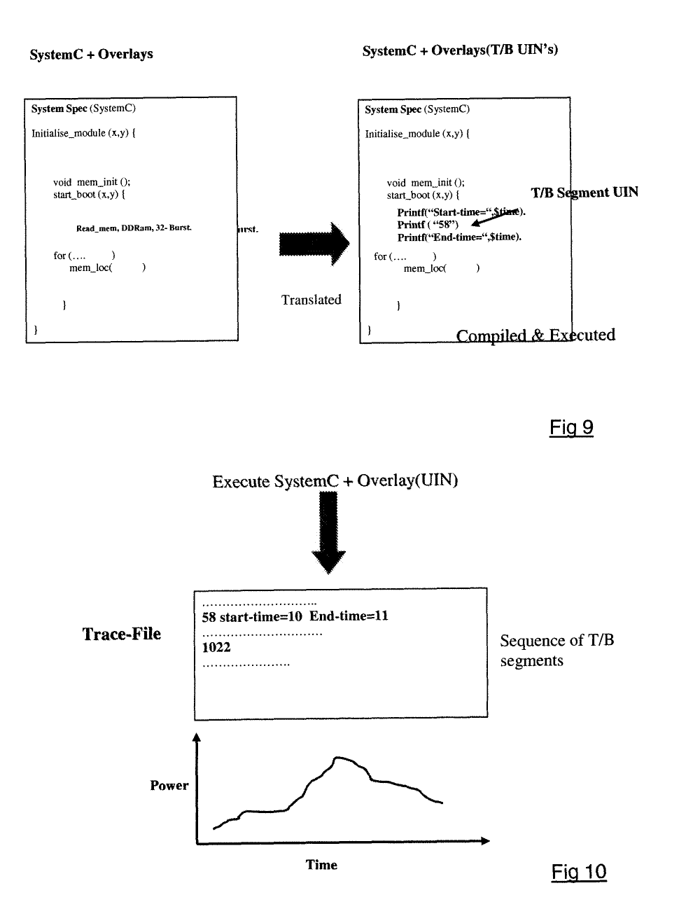

FIG. 9 shows a SystemC compile file according to the present invention;

FIG. 10 shows a power trace file according to the present invention;

FIG. 11 is a diagrammatic representation of a CPU system with a module hierarchy;

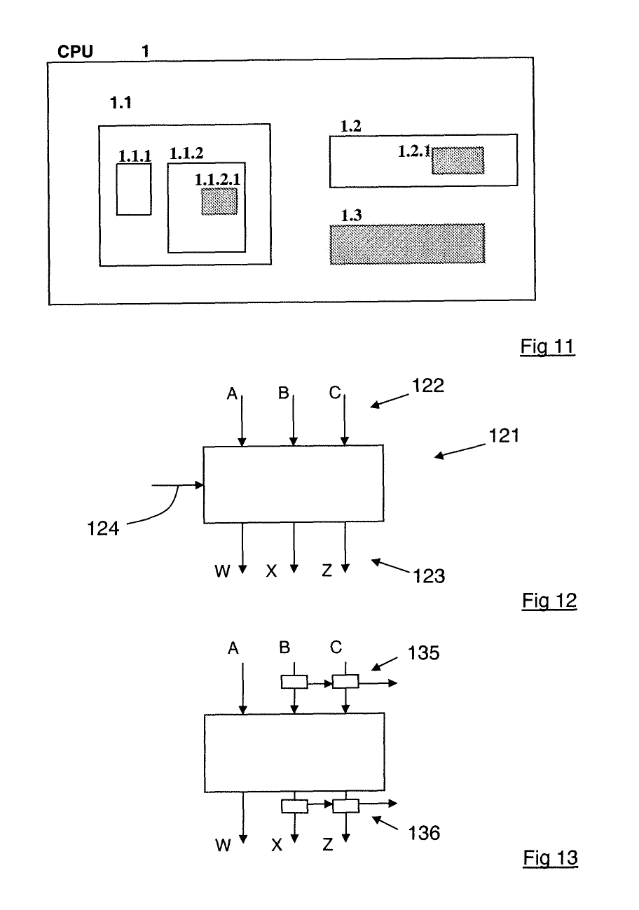

FIG. 12 is a diagrammatic representation of a module; and

FIG. 13 is a diagrammatic representation of the module of FIG. 12 whose inputs and outputs have been selected for the generation of a reduced power macro model.

Referring to the drawings and initially to FIG. 1 thereof there is shown a diagrammatic representation of a parallel processor known in the art. The parallel processor, indicated generally by the reference numeral 1 comprises an associative array 1a 3, an input value register bank 5, an associative array 1b 7, a test-result register bank 9, a group-result register bank 11 and a group-test hit-list 13. The associative array 1a 3 has a mask register 1a 15 and an input register 1a 17 associated therewith. Furthermore, the associative array 1b 7 has a mask register 1b 19 and an input register 1b 21 associated therewith. In addition to the above, the group-result register bank 11 has a mask register 25 and an input register 27 associated therewith. Finally, there are provided result activator registers 23, 29, a fan out memory 31, an input register 33 and an input value register 35.

In use, the parallel processor 1, commonly referred to as APPLES, is used in a parallel processing method of logic simulation comprising the steps of representing signals on a line over a time period as a bit sequence, evaluating the output of any logic gate including an evaluation of any inherent delay by a comparison between the bit sequences of its inputs to a predetermined series of bit patterns and identifying those logic gates whose outputs have changed over the time period. The logic gates whose outputs have changed over the time period are identified during the evaluation of the gate outputs as real gate changes and only those real gate changes are propagated to fan out gates. The control of the method is carried out in the associative memory mechanism which stores in word form a history of gate input signals by compiling a hit list register of logic gate state changes and uses a multiple response resolver forming part of the associative memory mechanism to generate an address for each hit, scan and transfer the results on the hit list to an output register for subsequent use. The processor and method allow for the segmentation of at least one of the registers or hit lists into smaller register hit lists to reduce computational time. Further the method and processor enable handling of line signal propagation by modeling signal delays. It will be understood that various other implementations of the associative memory mechanism could be provided and modifications to the structure described above could be made without departing from the spirit of the invention.

A more comprehensive description of the structure and operation of the APPLES processor may be found in WO01/01298 (University College Dublin), the entire disclosure of which and in particular the disclosure relating to the operation and structure of the APPLES processor is incorporated herein by way of reference. Furthermore, a comprehensive description of improvements to the structure and operation of the APPLES processor may be found in WO03/079237 (Neosera Systems Limited), the entire disclosure of which and in particular the disclosure relating to the structure and operation of the APPLES processor, the use of external memory and the segmentation of circuits to be simulated and their handling is incorporated herein by way of reference.

Referring to FIG. 2 of the drawings, there is shown a diagrammatic representation of a system incorporating an ENiGMA processor, indicated generally by the reference numeral 41, in which the analysis of digital circuits may be carried out. The system 41 incorporates an analysis system 42 for determining the power dissipation characteristics of a simulated digital circuit (not shown). Customer supplied data including customer testbench 43, customer library 45, customer design 47 and extracted parasitics (standard delay format (SDF) file) 49, are fed to the analysis system 42. The analysis system 42 comprises a testbench acceleration module 51, a library compiler 53, a netlist compiler 55 and an APPLES processor 57 for first of all compiling the data into a usable format and thereafter analyzing the data received from the customer. The analysed data is thereafter sent to a host pc (not shown) where the data is collated into a report format for display on a graphical user interface 59.

The user produces a number of text files that constitute a Verilog description of the circuit he or she intends to physically make. This is called the digital circuit design. The design is targeted towards a particular technology such as CMOS, BiCMOS or other technologies with smaller sized components. The manufacturer who offers this technology also produces a library in different formats that specify to a certain degree of accuracy the behavior of the elements of the library. These elements are typically referred to as cells and in a given library there will be cells of many different types. The digital circuit design is basically a list of connected cells. The designer will usually break his design into functional blocks called modules. Each module in turn may be broken down into its own component modules. A module hierarchy results from this procedure.

The digital circuit design is submitted to the modified processor. The ENiGMA tool, as the modified processor is otherwise referred to, is essentially made up of a simulation engine component and a power calculation component. The simulation engine comprises a parser and the APPLES simulation processor. The parser reads the design presented to it and creates a model (an APPLES model) of the design in a format that can be downloaded onto the modified APPLES simulation processor and processed. This model is functionally equivalent to the original design given certain constraints on the simulation complexity. The model is composed only of certain simple functional blocks that are called APPLES Primitive Types (APTs). In order to create the APPLES model, the parser reviews the Verilog netlist and the associated library. Then, for each component in the netlist, the parser accesses a file with APPLES equivalent sub-circuits and chooses the APPLES equivalent sub-circuit which is equivalent to the component in the netlist. The parser then builds the APPLES circuit for processing with the APPLES sub-circuits. In addition to the above, the parser stores an index of the APPLES sub-circuits and their equivalents in the original netlist. The simulation engine outputs a list of value changes in the APPLES model to the host PC that is consolidated in a file called the APPLES Model Value Change File (AMVCF) by a software component.

In a first mode of operation, the modified APPLES simulation engine has the capability to produce a file (called the transition count file TCF) that lists per simulation time unit (STU) how many transitions occurred on gates of each of the APTs. The ENiGMA power tool uses a file (called the Library Characterisation File (LCF)), derived from the library files of the technology the design targets, that specifies power consumption characteristics of each APPLES cell. Some processing is done and heuristics used to map from the library to the APPLES cells using some knowledge of what cells are used in the design. The ENiGMA tool then uses a simple iterative method to process the TCF and the LCF together to calculate the power consumed per STU using an equation also derived from the library. The advantage of this mode of operation of the ENiGMA processor is that it is fast and computationally efficient. The equation will depend on the component and the component library in particular. The power characteristics of a component are typically expressed in terms of an equation having a number of parameters that must be inserted into the equation in order to determine a power value for the particular state of the device. Alternatively, the power characteristics may be provided in tabular form.

In a second mode of operation of the ENiGMA processor, the ENiGMA tool works in a different manner. The modified APPLES processor is still a key component however the ENiGMA processor no longer uses the TCF to calculate power. Instead it uses the AMVCF. In this file every output change on an APPLES gate is identified individually. For every time step a list of gate numbers and values transitioned to is available. The power calculation then processes this data and produces a data structure that can be used to visualize the power calculation in any subset of the design modules. When the design is being parsed a number of databases describing pertinent design objects from the users Verilog description is created including the APPLES to Design cell relational Database (ADD), the Design Cell Database (DCB) and the Hierarchy Model. The power calculation program uses this database to relate the information returned by the modified APPLES processor to the original design. By doing this the processor can calculate power accurately using the library the user is targeting rather than the library that has been generated for the equivalent circuit. The processor processes the AMVCF entry by entry. For every entry it is aware of the time unit and it extracts the gate identifier (identifies an APPLES cell in the APPLES model) and the value identifier (identifies to which value the gate transitioned to). The software then determines from which cell in the users design this APPLES gate originated by fetching an entry from the ADD. It then finds this design cell in the DCB. The DCB can be annotated with any amount of information such as, interconnect capacitance, parent module specifier, state table for the cell instance. The design parser then annotates this database with all this instance specific information.

The present invention relates to a system level power evaluation method and a tool for use in such a method. The method comprises the steps of providing a system level circuit description (SLCD) containing a plurality of transactions for analysis, reviewing the SLCD and identifying those transactions of the SLCD that are equivalent to previously analysed transactions and those transactions of the SLCD that have no equivalent previously analysed transaction. A memory having a plurality of previously analysed transactions is provided and means are provided for analysing the transactions in the SLCD code. For each transaction of the SLCD that is equivalent to a previously analysed transaction, the method further comprises the steps of retrieving a power macro-model of the previously analysed transaction, that is associated with a case in memory, from memory, and assigning that power macro-model to the transactions in the SLCD. For each transaction of the SLCD that has no equivalent previously analysed transaction and hence no equivalent case or power macro model corresponding to the case stored in memory, the method comprises the steps of generating a case and a power macro-model for each of those transactions and assigning the generated power macro-model to the transaction in the SLCD. Finally, the method comprises using the plurality of power macro models, sample input vectors and sample output vectors, evaluating the power consumption of each of the transactions in the SLCD and summing the power consumption of each of the modules transactions to provide a system level power estimate.

It will be understood that in this specification, the term transaction has been used to define simple or complex operations or tasks that involve a module or modules and is to be construed having such meaning. Furthermore, the term case has been used to define a hardware physical module or a set of hardware physical modules and a context of operation defined by a series of input vectors. A module is a circuit component to be simulated or a group of circuit components to be simulated.

The tool used in the system level power evaluation method is known as the Rapid Hierarchical Energy Investigation Modeling System (RHEIMS), and is a System-level Case Based power exploration tool that delivers rapid and accurate power assessment on System-level prototypes written in SystemC, SystemVerilog, SystemVHDL or any similar type of transactional level language. Unlike Gate, RTL and other System-level power tools, RHEIMS automatically acquires, formats and expands its knowledge of power determinants from each successive gate-level design and transfers this information for use in a System-level context.

For accurate gate-level power determination in digital circuits, the following circuit data must be acquired during the course of a simulation: Gate description (cell library) and appropriate static and dynamic power models, interconnect, input/stimuli activity and internal switching activity. This data can be generated through gate-level simulation for a given input stimuli scenario defined by a Testbench. Furthermore, by taking input and output vector samples of arbitrary size and calculating the power consumption for each sample, a Power macro-model of a transaction or case can be constructed.

A power macro model is a four dimensional table indexed by the statistical energy macro-model parameters, Input probability (Prob_in), Average input transition density (Density_in), Average input spatial correlation coefficient (Spatial_corr_in) and Average output zero delay transition density (Density_out). These are calculated for each input vector block together with its energy value (En). A table is produced that can be used to determine the power consumption of a transaction for any input vector sequence without having to perform any detailed gate-level simulation. Instead the input and output vector statistics are determined and used to index a particular entry in the power macro model four dimensional table which specifies the energy consumption. As mentioned above, while accurate, power analysis at gate-level is very computationally intensive, hence the use of macro-models.

At the SystemC/Transactional level the circuit design is at such a high level of abstraction that the circuit is not defined in terms of gates. Furthermore, some of these details are only known to the Test engineer at the gate verification phase rather than the System designer. However, there is some resolution to this problem by virtue of design reuse in that new designs tend to be built from components or blocks from previous older designs.

The RHEIMS system classifies the power information of previous designs into a central database so that this knowledge can be utilised in assessing the power characteristics of new designs. This requires the power information gathered from the gate-level simulation performed at the test/verification phase of a design, to be systematically classified and these “Cases” stored in a d/base for future reference. Instances of these cases are then identified in new designs and consequently the power consumption of the new design estimated. A Case is defined by a Circuit and the Context of the input stimuli under which it is exercised. This is normally produced by the test/verification engineer through two components, a set of one or more gate-level physical modules that are active during the context of the case being specified and a testbench description which exercises the physical modules by generating input stimuli to them. The gate level netlist of the physical module(s) typically comprises the Verilog or VHDL netlist definition of a circuit generated by the synthesis of the RTL description of a circuit. The testbench description is the code written by the test engineer to test the design. It provides the various input stimuli, corresponding to simulated operating conditions, and monitors the response of the various components of the design.

In the present invention, the testbench developed by the test/verification engineer is written in Verilog/VHDL (or other equivalent RTL/Gate netlist language) at the RTL/Gate level as normal, but importantly is partitioned into segments. Testbench Segments are identified by headers and terminator text embedded in the Verilog/VHDL code and defined by keywords and a description. By using headers, terminators and descriptors that are perceived as comments by the Verilog/VHDL compiler they can be positioned in any location of the code without affecting the syntax and appear transparent. This is most important to the present invention. Two windows are presented during the segment definition phase. One window contains the original RTL/gate-level code of the Verilog/VHDL file for browsing. In another window this file is duplicated, and is annotated with the headers, terminators and descriptors defining the segments. These keywords are presented to the Designer through a user GUI when a new design is being created. Once created, the segments are stored in a segment tree database. Each unique testbench segment identifier corresponds to a path in a particular Testbench Segment Tree that is stored in a Testbench Segment Tree Database. The leaves in such trees correspond to Cases, each uniquely identified by an identifier.

Referring now to FIG. 3, there is shown a diagrammatic representation of the definition and structure of a segment, indicated generally by the reference numeral 61. The segment 61 belongs to a tree of type Memory 63 which has a descendancy of levels classified as Memory-type 65, Operation 67, Size 69 and Mode 71. This is illustrated by the declaration 73 which reads:
//&& Seg-type, Memory: memory-type/operation/size/mode

A particular Case (Testbench segment) in this tree of type Memory is instantiated through the command 75 which reads:
//&& Seg: DDRAM/Read_DDR/32X512k/single-mode.

The command/declaration 75 is followed by the //&& Description 77 which allows a text description of the case to be stated and which will be associated in the Tree database for this case along with other case specific information such as the selected Power macro-models of the physical modules that are active in the testbench segment. The testbench segment declarations in the annotated Verilog/VHDL file can be entered textually into the copy of the original file or alternatively through a menu system. These menus allow the creation of new cases and the extension, amendment and creation of new trees.

A Database-controller (not shown) has a Tree-Parser that scans the annotated file and produces segment-trees in the tree database for all the declared segments. The parser also produces a Unique Identity Number (UIN) for a leaf i.e., Case in a Tree. To achieve an efficient and unique numeric label, each root of a tree is given a unique integer number. Every other child of a node is given an integer number which is 1 greater than the last node child with the initial child being given the value 0. Thus, the case:
//&& Seg: DDRAM/Read_DDR/32X512k/single-mode
   has a tree and leaf uniquely identified by:
86/1/2/0/0
   as shown in FIG. 4.

The textual appearance of a case in the annotated file is defined as an Overlay. In addition to creating an annotated Verilog/VHDL file with the overlays, the RHEIMS system also produces a third file, a Verilog/VHDL Monitor file which is a copy of the original file but with two major modifications. Referring to FIG. 5 of the drawings, there is shown a code segment, indicated generally by the reference numeral 81. Immediately after the “begin” statement 83 defining the start of the code of the segment, a Print statement 85 is inserted (native to the Verilog or VHDL language) that will cause the UIN of the segment to be printed to a designated file together with a native language command of the simulator to print the simulation time of this event. Furthermore, immediately before the “end” statement 87 defining the end of the code of the segment, there is provided a Print statement 89 (native to the Verilog or VHDL language) that will cause the UIN of the segment to be printed to the designated file together with a native language command of the simulator to print the simulation time of this event. These two modifications (the pair of print statements) enable the execution of the original file to be monitored in terms of the segments defined in the code. This monitoring is also used to identify all the active modules within a segment.

In the annotated RTL file as shown in FIG. 3, commands are also inserted to indicate which of the Verilog/VHDL modules that are monitored, will additionally have Power macro-models generated from their simulated activity. These modules will have Power macro-models constructed from the course of their simulation in the testbench, which will be subsequently added to the Testbench Segment tree database as shown in FIG. 4 of the drawings.

The annotated overlay file is parsed before it is compiled and all overlays and commands are replaced by Verilog/VHDL, PLI and FLI code structures that accomplish their tasks. In this process the parser produces a monitor file which is compiled from Verilog/VHDL into an executable file as shown in FIG. 5 that is simulated.

The sequence in which the files are generated is shown in FIG. 6 of the drawings. In step 91, the original RTL/Gate level code in Verilog or VHDL for example is edited and overlays and monitor directives are added. In step 93, the edited code with overlays and monitor directives are parsed to form an annotated monitor file which is compiled and then executed in step 95.

During the course of the simulation, for every testbench segment the input and output activity of all associated physical modules is monitored. This input/output data is recorded and entered into a file, the Testbench Module Activity File that is transferred to the Power-macro model generator. The Testbench Module Activity File contains the following information/carries out the tasks of:
1. Storing the UIN of every active segment.
2. Identifying and detailing the internal module activity of all the Testbench Segments that were active in the simulation. This requires recording the time of all input and output vectors on each active module and the location and version of the module files.
3. It specifies modules for which Power macro-models are to be generated.
4. The input and output parameter list of the Power macro-model modules.
5. The cell library into which the modules will be synthesised.
6. It gives a unique file identifier to each synthesised module, a Synthesised File Id (SFI).

Referring to FIG. 7 of the drawings, there is illustrated a situation in which two physical modules, module_x 101 and module_y 103 are active in a testbench segment and consequently the input and output activity of these units are profiled. The Power-macro model generator (not shown) acquires or produces the synthesised gate-level version in the designated cell library of every physical module in the Testbench Module Activity File. For each Testbench Segment, it transfers the associated synthesised files to the ENiGMA system together with the appropriate time-sequenced input-vector list. The ENiGMA system computes the total power consumption of each Testbench segment and the power consumed by each monitored physical module in the segment, on a cycle by cycle basis and stores this information in a file or database for use by the Power macro-model generator.

With all the input and output vector activity data and the knowledge of the power consumed per cycle, the Power macro-model generator produces the following:
1) For the monitored Testbench segments, it computes the normal four dimensional tables with components Input probability (Prob_in), Average input transition density (Density_in), Average input spatial correlation coefficient (Spatial_corr_in) and Average output zero delay transition density (Density_out) and a corresponding Power value, but augmented with an additional field the Batch-time.
   Each entry in the Power macro-table has been constituted from a sample of input vectors (typically 50-100 vectors per table entry), the Batch-time indicates which batch sample from the complete input-vector stream was used in the generation of the entry. Since different batches may generate the same four dimensional value in the table, there can be several Batch-times in each table entry. The Batch-time filed permits a time-based energy profile of the associated module to be generated with a time resolution accurate to the number of samples used per entry. The frequency of operation and the operating voltage at which the table was generated is also recorded.
2) An Aggregate power value for the entire Testbench-segment detailing the total power consumed and consumption time, the frequency of operation and the operating voltage. This also permits a single power macro-model to be re-scaled for other operating voltages, frequencies and physical conditions.

The Power macro-model generator transfers, usually in a file, the power macro-models, UIN's, SFI's, aggregate power values, frequency and voltage information to the Database controller which amongst its tasks inserts this information into the appropriate position in the database. The Database controller also updates links to any other Power macro-model that has the same SFI. This permits the construction of a single larger power macro-model from constituent smaller tables distributed in the database.

When a power macro-model (PMM) is generated for a module or group of modules, it is used for reference during the course of future simulations. An example of a four dimensional PMM is shown in Table 1 below. The input and output signals (vectors) appropriate to the PMM are monitored in the simulation, and for a given set of input and output signals, various statistical metrics or measures such as the Average input signal probability, Average input transition density, Average input spatial correlation coefficient and Average output zero delay transition density are calculated and these are inserted as the parameters of the PMM. These metrics are used as an index into the PMM table in order to determine the power consumed by the module for the particular input set. The entry at the location of the table indexed by the statistical parameters specifies the power consumed. If there is an exact match between the index and one of the entries in the table then the power consumed by the module is given by the entry in the table.

TABLE 1
[Power Macro-model Table (PMM)]

| Parameter_1 | Parameter_2 | Parameter_3 | Parameter_4 | Power |
|---|---|---|---|---|
| 0.132 | 0.33 | 0.45 | 0.67 | 1.23 mW |

In the above table, index entry (0.132, 0.33, 0.45, 0.67) has a power consumption of 1.23 mW. The remaining index entries have been left blank for clarity. If there is no matching entry in the PMM for a given set of parameters, there are two ways of determining the power consumption for the given set of parameters. The first method comprises the following steps: In the event that there is not an exact match between the index and an entry in the table then the nearest neighbour entry can be taken. This requires calculating the Cartesian distance between the index and each entry. The Cartesian distance is defined as:

Let index=(I1,I2,I3,I4), Let any PMM entry=(E1,E2,E3,E4).

Cartesian Distance=[(I1−E1)²+(I2−E2)²+(I3−E3)²+(I4−E4)²]^{1/2} Eqt A

The power value of the entry which gives the smallest distance is taken as the value of the power consumed for the given index.

The second, alternative method for determining the power for a given set of indices comprises the following steps: The method uses a linear method of extrapolation and allows for weak or strong perturbation effects of the PMM parameters upon power. The Cartesian distance method as used in the first method described above is used to determine the four closest index entries to the given index. Typically, there will be no more that a few hundred entries in the PMM and therefore this not seen as too computationally burdensome. The power of the module(s) represented by the PMM is assumed to be linear in the parameters of the PMM in the vicinity of the four closest neighbours (as determined by the Cartesian distance) to the index. Thus:

Power_{index}=A.(Parameter_{—}1)_{index}+B.(Parameter_{—}2)_{index}+C.(Parameter_{—}3)_{index}+D.(Parameter_{—}4)_{index} Eqt B

Where Power_{index} is the power for the index and (Parameter_I)_{index} is the i^{th} parameter for the index, and, where A,B,C,D are constants. Constants A,B,C,D are determined by taking the four closest entries to the index, E1, E2, E3 and E4 in the PMM table and using the parameter and power values of these entries four linear equations are solved for the constants.

Power_{—}1=A.(Parameter_{—}1)ᵥₐₗ_{_{—}}₁+B.(Parameter_{—}2)ᵥₐₗ_{_{—}}₁+C.(Parameter_{—}3)ᵥₐₗ_{_{—}}₁+D.(Parameter_{—}4)ᵥₐₗ_{_{—}}₁ (Eqt1 from E1)

Power_{—}2=A.(Parameter_{—}1)ᵥₐₗ_{_{—}}₂+B.(Parameter_{—}2)ᵥₐₗ_{_{—}}₂+C.(Parameter_{—}3)ᵥₐₗ_{_{—}}₂+D.(Parameter_{—}4)ᵥₐₗ_{_{—}}₂ (Eqt2 from E2)

Power_{—}3=A.(Parameter_{—}1)ᵥₐₗ_{_{—}}₃+B.(Parameter_{—}2)ᵥₐₗ_{_{—}}₃+C.(Parameter_{—}3)ᵥₐₗ_{_{—}}₃+D.(Parameter_{—}4)ᵥₐₗ_{_{—}}₃ (Eqt3 from E3)

Power_{—}4=A.(Parameter_{—}1)ᵥₐₗ_{_{—}}₄+B.(Parameter_{—}2)ᵥₐₗ_{_{—}}₄+C.(Parameter_{—}3)ᵥₐₗ_{_{—}}₄+D.(Parameter_{—}4)ᵥₐₗ_{_{—}}₄ (Eqt4 from E4)

Where Power_I is the power value of i^{th} closest entry, and (Parameter_k)ᵥₐₗ_{_{—}}_{I} is the value of the k^{th} parameter of the i^{th} closest entry. The magnitude of the constants A, B, C and D also indicate the influence of perturbations in the various parameters on the power of the module(s) described by the PMM. The larger the magnitude of the constant the greater the influence on power. The constants can also be used to determine the error margin in the calculated power. For instance, a 5% error in parameter_{—}2 would lead to a 50% error margin in power if constant B=10 and the other contributors in Eqt B are more minor.

Referring to FIG. 8 of the drawings, there is shown an overlay being inserted into the code 111. The overlay is selected from a number of pull down menus 113 in a dedicated window 115. The menu allows for a specific case to be identified and then the overlay associated with that case can be inserted into the code and in due course the macro-model of that case may be obtained for power evaluation. As more Testbench segments are produced more cases are introduced into the database. These cases are available for selection and insertion as Overlays into SystemC files for system-level power evaluation. The Overlays annotate the original SystemC code and this produces a second annotated SystemC file as shown in FIG. 9. Each case indicates the action(s) that is executed at a gate-level for the corresponding SystemC operation.

FIG. 8 further depicts the Overlay and menu selection process. The SystemC user through a menu system is presented with a choice of keywords. These keywords define components, their physical attributes and actions that are performed on or by them. These are defined by the Testbench segments in the RTL/Gate-level code that have been stored in the database. The levels in a tree define a class which can have members attributed to it. For each level, a menu is generated consisting of the members in that class. The keywords that are presented in a given menu are those associated with the level in the descent of the Testbench segment tree. A Testbench Segment has been completely identified and selected, once a leaf node has been reached in the tree. At this stage the UIN of the segment is known. The SystemC user may request information and details regarding the selected segment from a Description file located at the leaf node. In certain instances, it may not be necessary to go to a leaf and a higher level, less specific description may be sufficient and a more general macro model for the less specific description may be provided.

The annotated SystemC Overlay file is parsed and translated into another SystemC file where each overlay has been replaced by a command which enables a trace of the program execution in terms of overlays (as shown in FIG. 9). This is typically a printf “UIN” (in C systems). The trace command is also preceded by a command which invokes the time during execution when the printf or equivalent is initiated and terminated by a command which invokes the time when the printf command has concluded. Through this structure it is possible to trace the parallel and sequential execution of the overlays. After the SystemC file with traceable UIN code has been compiled, it is executed and apart from any input or output data by the SystemC code itself, the UIN traces will be reported to a Trace file. The Trace file consists of UIN identifiers and the time when they were started and finished execution. This file is parsed and the time sequence of the UIN's is determined. The power consumption and duration of each UIN is extracted from the Testbench segment database through the UIN index. A time line of power consumption can be generated from this information and a power trace file as shown in FIG. 10 may be generated.

In addition to the above features, selected overlays can be combined into a designated Operational Group. An operational group is distinguished by the voltage and frequency of operation which can be specified in the SystemC file. This permits different operations in the SystemC file to be assigned to different physical blocks that can operate at different voltages and frequencies. This permits Voltage Islands and Frequency scaling to be simulated at a SystemC level. The power consumption for any segment can be scaled according to voltage or frequency since the physical conditions at which the Power macro-models and Aggregate power values were calculated is stored in the segment database.

Using Operational groups and design constraints, the optimal operating conditions with respect to voltage and frequency and gated clocking can be determined by simulated annealing or other combinatorial optimisation techniques with a cost function expressed in these variables. Furthermore, power effects in a design can be considered by indicating average length and capacitance values of wires connecting Input and Output ports and or other major wires in the design. Finally, the Power macro-models can be utilised in RTL simulations for power estimation. The modules in the RTL file are referenced in the segment database and the input stream to these RTL modules are transferred into the macro-models.

It will be understood from the foregoing that there are numerous advantageous novel and inventive aspects of the present invention including but not limited to the segmentation of the RTL/Gate-level Testbench into user defined segments that are subsequently stored in a Segment Tree Database; the case classification process of Testbench segments into Testbench segment trees; the process of having an original SystemC file, annotated by Overlays in another file which is subsequently parsed into an annotated monitor file and executed; the profiling and monitoring of the active RTL/gate-level modules within a testbench segment and association with the classification process in the testbench segment database of the power consumed in the segment into Aggregate Power Tables and module Power macro-models; and, the linking of several distributed module Power macro-models in the Segment tree database into one composite module Power macro-model.

Furthermore, other novel and inventive advantageous aspects of the present invention include the augmentation of the Power macro-model tables with Batch-time information to permit the reconstitution of power consumption with time; the guidance of the SystemC Overlay insertion process by the structure of the Testbench segment tree; the production of a SystemC file annotated by Overlays; the production of a SystemC file with Overlays translated into Unique Identity Numbers (UIN's) and time trace commands; the collection of overlays into Operational groups, defined by physical operating conditions; and, using Operational groups and design constraints in a simulated annealing process or other combinatorial optimisation technique to find optimal operating conditions.

The Trace file chronological sequence is defined in terms of time as given by the SystemC simulation kernel. This is translated into Relative or Absolute times within the time-frame of the case components by using the duration specified for each case in the database. For example, if we suppose that a trace file has two Cases (or Overlays) C1 and C2 and both have the same monitored commencement time 2791452 (i.e. they are executing in parallel) as given by the SystemC simulation kernel, corresponding to some event in the SystemC simulation that initiated their parallel activity. Suppose also, that the termination times are 2791850 and 2792800 respectively as specified by the kernel. In terms of the SystemC cases and their components relative to the start of their execution, T_{commencment}, the actions associated with these cases will terminate at T_{commencment}+D1 and T_{commencment}+D2, where D1 and D2 are the duration times of the cases C1 and C2 as stored in the database.

Taking another example, if there are four cases in a trace file that execute sequentially after each other, C1, C2, C3 and C4, each of duration D1, D2, D3 and D4 respectively. Then, relative to the start of C1, C4 will commence at a time D1+D2+D3 in the SystemC case time frame. If an event in the SystemC can be given an absolute time in the SystemC case time-frame, then providing all activities, tasks or transactions relative to this can be given a duration time or subsequent events an absolute case time, an absolute case time-frame can be established. Otherwise, a case time-frame relative to some common event is established.

Referring now to FIG. 11, there is shown a CPU system with a module hierarchy. The module hierarchy and method according to the invention permits more flexibility in defining cases. Taking the CPU system with the module hierarchy shown in FIG. 11 of the drawings, if there is a \CPU\Reset case specifying a Reset operation on the CPU which only involves the hardware modules 1.3, 1.2.1 and 1.1.2.1, then only these modules will be incorporated into the power macro-model for this case. This set of modules does not follow the hierarchy of the modules of the CPU.

To reduce the number of inputs that need to be used in the generation of power macro-models (PMM) parameters, it is possible to develop a power model based on the inputs and/or outputs to or from a digital synchronous circuit that are most correlated to changes in the module's power output. The power model that is generated using the statistics of the module inputs and/or outputs most correlated to power, will most probably be more accurate for an input vector stream of a given width. It is also more likely to produce more accurate results when used to estimate power.

One aspect of the invention is to determine which inputs and/or outputs of a module are highly correlated to the module power consumption. This entails monitoring the signal behaviour of each input and output over a designated or arbitrary period of time and using a correlation function between it and the module power over the same period, or periods of time shifted by an integral number of clock periods of the module.

Referring to FIG. 12, the module indicated generally by reference numeral 121 has three inputs A, B and C, indicated generally by reference numeral 122, three outputs W, X and Z indicated generally by reference numeral 123 and a Clock signal 124. The power or current consumed by the module is either measured physically, or alternatively a gate, or transistor model of the module is simulated and the current or power calculated based on the simulation. For any given time period, T₁ , the power consumption of the module can be determined and the input behaviour of any digital input or output behaviour of any digital output can be monitored over a pre-determined or arbitrary period of time prior to T₁. Using the two signals (the power signal and the chosen input and/or output signal) a cross correlation function is applied based on the number of transitions and the level (0, 1) of the input or output signal and the power consumption of the module at the end of clock cycle.

This cross correlation process can be repeated between each individual input or output signal and the power consumption. Eventually, an ordered list of correlated inputs and/or outputs can be produced which indicate those inputs and/or output signals that most correlated to module power consumption. From this list an arbitrary or pre-defined number of input signals and/or output signals can be selected to be used in the generation of the parameters of the power macro-model of the module. The accuracy of the power macro-model can be specified and the appropriate minimum number of input and output signals to achieve this accuracy can be determined and selected. The selected input and/or output signals can be used to generate a power macro-model for one or more modules instead of using all of the input and output signals. This power macro-model is called a reduced power macro-model (RPMM).

Referring to FIG. 13, the input signals B and C and the output signals X and Z are the signals that have been determined in the above process to be incorporated in a RPMM as they are the most closely correlated to the power signal. Input signal A and output signal W have been disregarded. The selected input signals can also be incorporated into a Scan-path structure which permits the signal values on these inputs to be scanned out through a scan chain and observed during the run-time of the module. Implementation of a scan path structure itself is well known and therefore no further description of a scan path structure is deemed necessary for the understanding of the present invention. Using a scan-path method the values of the input power correlated signals can be transmitted to one or more output pins of the chip where they can be observed at the end of every clock cycle. The input signal scan chain is shown in FIG. 13 by reference numeral 135. Alternatively, the scan chain values of the input signals can be transmitted to a register for on-chip use. The output response of the module(s) can also be part of a Scan-path structure, so that the output of the module(s) can be observed externally. Alternatively, the scan chain values of the output signals can be transmitted to a register for on-chip use. The output signal scan chain is identified in FIG. 13 by reference numeral 136. At the end, every cycle of these new scan-chain values is used to determine the parameter values that will be used in the power macro-model of the module(s). These scan chain values can be transmitted to a computer system that can store the values at the end of every cycle into a file or otherwise, where they can be accessed to determine the parameter values that will be used with the reduced power macro-model of the module resident on the computer system.

The computer system can be external to the chip of which the module(s) is a part or alternatively it can be on-chip. It is also possible to perform on-chip, in hardware the parameter calculations, rather than scan-out the input signals for the reduced power macro-model. In this instance, it is only necessary to transmit via a scan-path, or store the result of the statistical calculation at the end of a block of input vectors. Hardware can also be implemented on the same chip as the output signals of the module(s) that can perform the statistical computation such as the Average output zero delay transition density. In the former case, it is only necessary to transmit via a scan-path, or store the result of the statistical calculation at the end of a block of input vectors. Apart from determining the power consumption of various modules, the information can be used dynamically by any embedded software controlling the chip, to perform power management activities.

It will be understood from the foregoing description of FIGS. 12 and 13 that the techniques described therein are suitable for application once the chip has been realized and it is desirable to carry out further power analysis of the chip in hardware. This may allow for further power savings to be made. For example, programming changes may be made to the code that it is intended to run on the chip in order to make additional savings and obviate the occurrence of power spikes.

The above method is different from established real-time techniques known in the art. In the known techniques, on-chip counters are used to record the number of internal states transacted by a digital circuit during its execution. Each state has a pre-determined energy associated with it. Thus summing all states encountered computes the total power. This has limitations when there are a large number of states as these must be identified and a counter allocated to each state. In another known method, linear equations are used to predict power. However, the equations must be characterised to the physical operating conditions such as frequency, transistor die and layout. Furthermore, the instruction stream exercising the design affects the constants in the equation. Therefore, the equations are focused on a very limited operational window. Other real-time power estimation techniques are mainly concerned with power assessment at instruction-level.

The system and method described produces a trace file of the various power cases executed during the course of a system-level simulation of a particular design. This trace files details the sequence of the power cases that were executed in the annotated system-level. A Power-Profile file is produced from the trace file by accessing the database of power cases.

For each case in the trace file, its power consumption is calculated subject to its operational frequency and voltage. This file can be used as a Cost function in a Simulated Annealing process to minimise the power consumption in a design subject to various design constraints. There are numerous constraints that can be used. For example, a) the minimum and maximum operating voltage of a module, b) the minimum and maximum operating frequency of a module, c) the maximum number of Voltage Supply Levels/Voltage Islands in the design and d) the maximum number or location of Gated clocks in the design.

The simulated annealing algorithm will now be described in greater detail following the following steps: (1) First of all, Power Profiles of the components are extracted from the Trace File. Each component is assigned initial operational constraints. The initial Temperature T₀ is set. (2) Next, for the initial set of parameters, the power profile is produced from a system-level simulation. (3) Then, the Cost function for any power profile is defined as:

$$Cost = {W}_{1} {\cdot \sum }_{i = 1}^{No . of Cases} ( Power of Case [ i ] ) . ( No . Occurences [ i ] ) + {W}_{2} \cdot ( No . of Different supply voltages ) + {W}_{3} \cdot ( Performance of design ) + {W}_{4} \cdot ( No . of gated clocks )$$

Where W₁,W₂,W₃ and W₄ are weights dependent on the architecture and technology of the design being simulated. Where “No. Occurrences[i]”=The number of times that Case[i] occurs in the trace file. Where “No. of Different supply voltages”=The number of different supply voltages that must be implemented in order to supply power to the various voltage islands and devices in the design. Where “Performance of design”=The overall speed of the design determined by assigning execution times from the RHEiMS d/base of each case in the trace file. And where “No. of gated Clocks”=The number of gated clocks that are introduced into the design at the system-level stage. These are specified with the constraints.

(4) Thereafter, the Cases in the trace file are listed in decreasing order of power consumption. (5) An arbitrary or defined number of the top largest power consuming cases are selected and their individual power consumption is reduced by varying voltage and/or frequency subject to the operational constraints of the design. (6) All operational parameters, in all the cases in the trace file are updated in accordance with the assignments made in the previous step (step 5). (7) The new solution defined by the two previous sequential steps (steps 5 and 6) above is accepted or rejected according to:

If Cost(New Solution) < Cost (Old Solution) then Replace Old Solution
by New Solution
else

begin

If Cost(New Solution) > Cost(Old Solution) then
If Random(0,1) < e ^{-[Cost(New Solution) -Cost(old Solution)]/T} then
Replace Old solution by New Solution
End

Where Old Solution=The values of the operational parameters of the cases in the trace file prior to the modification in the steps described above and T=Temperature.

Once the above has been completed, the method proceeds to step (8) in which the temperature is decreased. The incremental decrease need not be the same in each iteration. (9) Finally, steps 4 to 8 are repeated until one or more of the following conditions are satisfied: (a) the Temperature is below a certain threshold, (b) steps 4 to 8 have been repeated a specified number of times, (c) an attempt to generate a new set of parameters which satisfied the constraints was not successful for a specified number of times, or (d) the user stops the algorithm through the RHEiMS, Simulated Annealing Interface. It will be understood by the skilled addressee that “temperature” referred to in the above equation and description thereof is not the physical temperature but is a term specific to simulated annealing techniques that relates to a variable value.

In addition to the previous comments made in relation to the prior art, it is felt advantageous to identify some other differences between the disclosures in the prior art and the application in suit and some advantageous aspects of the present invention. First of all, in relation to Dhanwada, identified above, this paper relates to a method of power estimation for a SystemC functional model designed to run embedded software. Dhanwada focuses on System-level power with Transactional Level Models (TLMs) from a PowerPC Core-connect platform. There are a number of Key Distinctions between Dhanwada and the application in suit. First of all, in Dhanwada, all of the communications within the TLM platform use blocking transactions. In the present invention, transactions can run in parallel i.e. they can run as Non-blocking or Blocking. This is possible because the point of execution of a case (overlay) is ultimately translated into a SystemC time frame which permits parallel execution.

Secondly, Dhanwada uses a HTLP (Hierarchical Transaction Level Power) Tree that has a structure that reflects the gate-level module hierarchy of the cores. Each node is a power representation corresponding to a particular module in the physical hierarchy. In the present invention however, nodes may have power macro-models. This is a consequence of the structure of a case. A case can be any level of granularity and can be defined in terms of components and operations and any other classification that the RTL test engineer may wish to use. Within any path to a leaf there is an implicit operation defined on a set of modules. The operation may be subsequently further refined which will extend the tree and create new leaf nodes. For example, \cpu-components\mem\Dram\read defines a path which has a leaf node which contains a power macro-model for a Dram Read operation. There are no power macro-models at nodes, \cpu-components, \cpu-components\mem, \cpu-components\mem\Dram as these just define a physical aspect of a case. There is a power macro-model at the case \cpu-components\mem\Dram\read. This case can be further refined to \cpu-components\mem\Dram\read\16-bit to classify a case which is not simply a Dram Read operation but more specifically a 16-bit Dram Read.

Thirdly, in Dhanwada, the nodes in the HTLP follow the hierarchy of modules in the core components in the PowerPC Core-connect architecture. The tree is core not case based. There are no RTL defined cases. In the present invention, the active components (modules) in a segment can transcend and extend across several disjoint modules in the circuit module hierarchy. This permits more flexibility in defining cases. For example, taking a CPU system with the module hierarchy shown in FIG. 11 of the drawings, if there is a \CPU\Reset case specifying a Reset operation on the CPU which only involves the hardware modules 1.3, 1.2.1 and 1.1.2.1, then only these modules will be incorporated into the power macro-model for this case. This set of modules does not follow the hierarchy of the modules of the CPU.

In addition to the above, in Dhanwada, there are no power macro-models equivalent to those described in the present invention. In the method and system according to the present invention, power macro-models with the same SFI are linked together from different cases. This permits all the cases in which a module has been involved to be effectively incorporated into one power macro-model. The linking logically combines a series of smaller power macro-models of a module that are distributed throughout the database into one larger power macro-model. These power macro-models can also be used in RTL simulation to provide rapid module power calculation and analysis.

Furthermore, perhaps most importantly, Dhanwada indicates that only average power figures are used in the HTLP tree. In addition to this, the representations are only parameterised to settings specific to the core, for example data width and channel priority and the power computation has no cycle reference. This cannot provide for highly accurate power estimation. In the method according to the present invention, the macro-models are augmented with Batch-time information allowing cycle time-based analysis to within the degree of resolution determined by the number of cycle per sample used for each entry in the power macro-model. In Dhanwada, Power representation calls are inserted directly into the appropriate SystemC function. These calls are defined from a databook of the core. The user can make a choice of which transactions from the databook to use in the SystemC and power representations are then generated. During execution of the SystemC code calls are made to various power representations. While total power is determined as the sum of the average power of each transaction there is no reference to a power time-based profile capability. On the other hand, in the present application, cases and their Power macro-models are entirely at the discretion of the RTL test engineer, they can be very simple or complex and independent of the hierarchy. Furthermore, a time-based power macro-model is created and there is a power time-based capability in the embodiments of the present invention.

Finally, in Dhanwada, the contribution of interconnect to power between different physical blocks is not considered. Interconnect between gates in a core or hierarchy is taken into account through place and route information and is fixed. In the present invention, the concept of Operational groups allows intra-module communication to be modeled with different physical characteristics which is highly beneficial.

In relation to the disclosure in Bona, identified above, the paper presents a methodology for automatically generating energy representations of parametric on-chip components. An STBus class library is augmented with various power profiling features. This document describes how an energy representation of the whole STBus interconnection is partitioned into sub-components, corresponding to a micro-architectural block of the interconnection fabric. Similar to Dhanwada, the power representations are defined by the STBus hierarchy and the operations associated with the hierarchy blocks such as average latency per master request. Bona is not a generic methodology and the power representations are specific to the STBus architecture. A node module, representing a configurable switch is configured by an 8-tuple (a switch with 8 coefficients defining its characteristics), consisting of various network coefficients.

Furthermore, the energy representation of a node in Bona is defined in terms of packet activity. It is not a generic 4-tuple power macro-model as claimed in the present invention. The node energy representation leads to a computationally intensive characterisation problem that must addressed by a Response Surface Method and therefore, Bona is only applicable to communication and packet transmission type applications. The present invention does not experience such limitations.

It will be understood that the present invention may be implemented largely in software. Therefore, the invention also extends to computer programs, particularly to computer programs on or in a carrier, adapted for putting the invention into practice. The program may be in the form of source code, object code or code intermediate source and object code. The program may be stored on a carrier such as any known computer readable medium such as a floppy disc, ROM, CD ROM or DVD, memory stick, flash drive or the like. The carrier may be a transmissible carrier for when the program code is transmitted electronically or downloaded or uploaded through the internet such as an electrical or optical signal, which may be conveyed via electrical or optical cable or by radio, satellite or other means. When the program is embodied on a signal, which may be conveyed directly by a cable or other device, the carrier may be constituted by such a cable or other device means. It is further envisaged that the computer program may be stored in an integrated circuit.

In this specification the terms “comprise, comprises, comprised and comprising” and the terms “include, includes, included and including” are deemed totally interchangeable and should be afforded the widest possible interpretation.

The invention is in no way limited to the embodiment hereinbefore described but may be varied in both construction and detail within the scope of the claims.

1-73. (canceled)

74. A system level power evaluation method comprising the steps of:
providing a system level circuit description (SLCD) containing a plurality of operations of modules for analysis;
reviewing the SLCD and identifying those operations of modules of the SLCD that are equivalent to a previously analysed case, a case comprising an operation of a module, and those operations of modules of the SLCD that have no equivalent previously analysed case;
for each operation of module of the SLCD that is equivalent to a previously analysed case, retrieving a power macro-model of the previously analysed case from memory and assigning that power macro-model to that operation of module in the SLCD;
for each operation of module of the SLCD that has no equivalent previously analysed case, generating a power macro-model for each operation of module and assigning that generated power macro-model to that operation of module in the SLCD; and
using the plurality of power macro-models, sample input vectors and sample output vectors, evaluating the power consumption of each of the operation of modules in the SLCD and summing the power consumption of each of the operation of modules to provide a system level power estimate.

75. A method as claimed in claim 74 comprising the initial step of the user defining a case, the case comprising an operation of a module.

76. A method as claimed in claim 75 comprising the initial step of the user defining the case, the case comprising a plurality of operations of a module.

77. A method as claimed in claim 75 comprising the initial step of the user defining the case, the case comprising a plurality of modules.

78. A method as claimed in claim 74 in which the step of generating a power macro-model further comprises the steps of:
obtaining a gate level description of the module;
simulating the gate level description of the module using the plurality of sample input vectors and sample output vectors;
calculating the gate level power consumption for the sample vectors used in the simulation; and
constructing a power macro-model using the sample input vectors, sample output vectors and calculated power consumption values for the sample vectors.

79. A method as claimed in claim 74 in which the generated power macro-models are stored in memory for subsequent use in the power evaluation of other SLCDs.

80. A method as claimed in claim 74 in which the step of generating a power macro-model comprises generating a four dimensional table indexed by statistical energy macro model parameters.

81. A method as claimed in claim 80 in which the statistical energy macro model parameters used to index the four dimensional table comprise:
(a) Input probability
(b) Average input transition density
(c) Average input spatial correlation co-efficient
(d) Average output zero delay transition density

82. A method as claimed in claim 80 in which the statistical energy macro model parameters are calculated using a plurality of the sample input vectors together with the sample output vectors.

83. A method as claimed in claim 80 in which the parameters are used to index a value of power consumption in the power macro model.

84. A method as claimed in claim 74 in which the power macro-models of modules are stored under the equivalent case name in a central database.

85. A method as claimed in claim 74 in which the cases are defined by
(a) a circuit description; and
(b) a context of the input stimuli under which the circuit is exercised.

86. A method as claimed in claim 85 in which the circuit description further comprises a gate level netlist of the module.

87. A method as claimed in claim 86 in which the gate level netlist comprises one of a Verilog and a VHDL netlist definition of a circuit generated by the synthesis of a Register Transfer Level (RTL) description of the circuit.

88. A method as claimed in claim 85 in which the context of the input stimuli under which the circuit is exercised further comprises a testbench description.

89. A method as claimed in claim 88 in which the testbench description is written in one of Verilog and VHDL.

90. A method as claimed in claim 88 in which the testbench description is written at one of the RTL and the gate level.

91. A method as claimed in claim 88 in which the testbench description is partitioned into segments.

92. A method as claimed in claim 91 in which the segments of the testbench description are annotated.

93. A method as claimed in claim 91 in which the testbench segments are identified by segment identifiers including headers and terminator text embedded in the testbench description.

94. A method as claimed in claim 91 in which the testbench segments are defined by segment descriptors including at least one of keywords and a description embedded in the testbench description.

95. A method as claimed in claim 93 in which the segment identifiers and segment descriptors are entered in the testbench description in comment format.

96. A method as claimed in claim 95 in which the method further comprises the step of entering one of a segment identifier and a segment descriptor into the testbench description, and in which during the step of entering one of the segment identifier and descriptor, a pair of windows are presented to the user, a first window with the testbench description and a second window with the annotated testbench description with segment identifiers and descriptors inserted therein.

97. A method as claimed in claim 92 in which the method further comprises the step of a database controller tree parser parsing the annotated testbench description and producing segment trees in a tree database.

98. A method as claimed in claim 97 in which the segment tree comprises a plurality of leaves, each leaf in the segment tree corresponding to a case and in which the segment identifiers correspond to a path in the tree, and the database controller's tree parser produces a unique identity number for each leaf in the tree.

99. A method as claimed in claim 91 in which a monitor file is produced, the monitor file comprising the original testbench description and a pair of print statements associated with each segment in the testbench description, one at the beginning of the segment and the other at the end of the segment and in which the print statements cause the simulation time of execution of the print statement to be printed to a designated file along with an identifier of the segment.

100. A method as claimed in claim 99 in which the method further comprises the step of inserting commands in the overlay/monitor file to indicate which of the modules will have a power macro model generated from their simulated activity.

101. A method as claimed in claim 100 in which those modules identified as requiring power macro models are simulated and have power macro models constructed from the simulation.

102. A method as claimed in claim 92 in which the annotated testbench description is parsed and thereafter compiled.

103. A method as claimed in claim 102 in which the step of parsing the annotated testbench description comprises replacing all overlays and commands with one of Verilog PLI and VHDL FLI code structures and generating a monitor file.

104. A method as claimed in claim 103 in which the step of compiling the parsed annotated testbench description further comprises generating an executable file and thereafter simulating the executable file.

105. A method as claimed in claim 104 in which the input and output activity of each of the modules is monitored for each testbench segment during simulation.

106. A method as claimed in claim 105 in which the input and output activity are entered into a testbench module activity (TMA) file.

107. A method as claimed in claim 106 in which the TMA file further contains:
(a) a Unique Identity Number (UIN) of each active segment;
(b) internal module activity of all testbench segments active in the simulation;
(c) identification of modules for which power macro-models are to be created;
(d) input/output parameter lists of power macro-models;
(e) the cell library into which the modules will be synthesised; and
(f) a unique file identifier of each synthesised module, a synthesised file ID (SFI).

108. A method as claimed in claim 106 in which the TMA file is transferred to a power macro-model generator.

109. A method as claimed in claim 108 in which the power macro-model generator acquires or produces the synthesised gate-level version in the designated cell library for every module in the TMA file.

110. A method as claimed in claim 109 in which for each segment, the power macro-model generator transfers the associated synthesised files to an ENIGMA system operating using an Apples processor together with the appropriate time sequenced vector input list.

111. A method as claimed in claim 110 in which the ENIGMA system computes the total power consumption of each testbench segment.

112. A method as claimed in claim 110 in which the ENIGMA system computes the power consumption of each module in each testbench segment.

113. A method as claimed in claim 110 in which the ENIGMA system calculates the power consumption on a cycle by cycle basis.

114. A method as claimed in claim 111 in which the power consumption data is stored for subsequent use by the power macro-model generator.

115. A method as claimed in claim 108 in which the power macro-model generator, using the input and output vector activity data and the power consumption data, generates a four dimensional macro-model table for each monitored testbench segment that does not already have a macro-model associated therewith.

116. A method as claimed in claim 42 in which the four dimensional table has the following parameters:
(a) Input probability;
(b) Average input transition density;
(c) Average input spatial correlation co-efficient;
(d) Average output zero delay transition density;
along with a corresponding power value.

117. A method as claimed in claim 116 in which the components are augmented with the batch time which indicates which batch sample was used from an input vector stream in the generation of the four dimensional table entry.

118. A method as claimed in claim 117 in which the method comprises the step of generating a time based energy profile of the associated energy modules.

119. A method as claimed in claim 116 in which the method comprises the step of recording the frequency of operation during the simulation.

120. A method as claimed in claim 116 in which the method comprises the step of recording the operating voltage during the simulation.

121. A method as claimed in claim 116 in which the method further comprises the step of generating an aggregate power value for the entire testbench including total power consumed, consumption time, frequency of operation and operating voltage.

122. A method as claimed in claim 108 further comprising the step of the power macro-model generator transferring:
(a) the power macro models
(b) the UINs
(c) the SFIs
(d) the aggregate power values
(e) the frequency information
(f) the voltage information
to a database controller and in which the database controller inserts the received information into the central database.

123. A method as claimed in claim 122 further comprising the step of the database controller updating links to any other power macro-model with the same SFI as the power macro models being inserted into the database.

124. A method as claimed in claim 74 in which the method comprises the step of generating a single larger macro model from constituent power macro-model tables distributed in a database.

125. A method as claimed in claim 74 in which the method comprises the step of using a case in a database as an overlay in a SLCD for system level power evaluation.

126. A method as claimed in claim 74 in which the method comprises the step of annotating the SLCD file with overlays.

127. A method as claimed in claim 126 in which the method comprises the step of parsing the annotated SLCD file and translating the parsed SLCD file into a monitor SLCD file containing trace commands.

128. A method as claimed in claim 127 in which the trace commands comprise a print command to print a segment UID and the time of execution of the print command.

129. A method as claimed in claim 127 in which the method further comprises the step of compiling the monitor SLCD file.

130. A method as claimed in claim 128 in which the method further comprises the step of executing the compiled SLCD file.

131. A method as claimed in claim 130 in which the UID and the trace commands are stored in a trace file.

132. A method as claimed in claim 131 in which the trace file is parsed and the time sequence of the UIDs is determined.

133. A method as claimed in claim 132 in which the power consumption and duration of each UID is extracted from the testbench segment database through a UID index.

134. A method as claimed in claim 133 in which a time line of power consumption is generated.

135. A method as claimed in claim 125 in which overlays are combined into an operational group.

136. A method as claimed in claim 135 in which the operational groups are distinguished by one of voltage and operating frequency.

137. A method as claimed in claim 136 in which the method further comprises the step of simulating voltage islands at a system level.

138. A method as claimed in claim 136 in which the method further comprises the step of simulating frequency scaling at a system level.

139. A method as claimed in claim 137 in which the method further comprises the step of determining optimal voltage and frequency operating conditions at a system level using the operational groups.

140. A method as claimed in claim 137 in which the method further comprises the step of determining optimal gated clocking operating conditions at a system level using the operational groups.

141. A method as claimed in claim 139 in which the method further comprises using combinatorial optimisation techniques to determine the optimal operating conditions.

142. A method as claimed in claim 141 in which the combinatorial optimisation technique used is a simulated annealing technique.

143. A method as claimed in claim 74 in which the power effect in the SLCD at a system level may be determined by providing average length and capacitance values of interconnect wires.

144. A computer program comprising program instructions for causing a computer to carry out the method of any preceding claim.

145. A computer program as claimed in claim 144 stored on a computer readable medium.
